(19) United States
(12) Patent Application Publication
(10) Pub. No.: US 2026/0019242 A1
(43) Pub. Date: Jan. 15, 2026

(54) IMPROVED QKD COMPONENTS

(71) Applicant: British Telecommunications Public Limited Company, London Greater London (GB)

(72) Inventor: Andrew LORD, London Greater London (GB)

(21) Appl. No.: 18/881,989

(22) PCT Filed: Jun. 13, 2023
(86) PCT No.: PCT/EP2023/065776

§ 371 Date: Jan. 7, 2025

(30) Foreign Application Priority Data
Jul. 12, 2022 (EP) 22184333.7

(51) Int. Cl. H04L 9/08; H04B 10/70

(52) U.S. Cl. CPC H04L 9/0852; H04B 10/70

(57) ABSTRACT

There is herein disclosed an apparatus for performing quantum key distribution, the apparatus comprising a plurality of connected functional components which, in use, co-operate to perform quantum key distribution, wherein one or more of the plurality of functional components is provisioned in a module, the module being relocatable relative to the remainder of the plurality of functional components.

Quantum Key Distribution (QKD) is a method of establishing a secret key using the principles of quantum mechanics. Its importance as a cryptographic technique is growing. One reason for this is concern over the potential power of quantum computing as an encryption-breaking technique.

QKD requires the preparation of information in quantum states. Complex, specialised equipment is required to produce such quantum states. This results in systems being expensive to provide and run. It is desirable to decrease the cost associated with such systems.

It would be desirable to provide a QKD apparatus which overcomes and/or substantially mitigates some or all of the above-mentioned and or other drawbacks of the prior art.

According to a first aspect of the invention there is provided an apparatus for performing quantum key distribution, the apparatus comprising:
a plurality of connected functional components which, in use, co-operate to perform quantum key distribution,
wherein one or more of the plurality of functional components is provisioned in a module, the module being relocatable relative to the remainder of the plurality of functional components.

The present invention enables methods of QKD to be performed in which one or more of the components is located remotely from the others. This results in space-saving at the quantum node. Furthermore, the remote component can serve multiple QKD apparatuses, bringing cost savings.

In some embodiments a single one of the plurality of functional components is provisioned in the module. In some embodiments, each of the plurality of functional components are provisioned in a separate module. In these embodiments, each of the modules may be relocatable relative to the other modules. The one or more modules may be separable from the remainder of the plurality of functional components.

The one or more modules may be located remotely from the remainder of the plurality of functional components. In some embodiments, the functional component that is provisioned in the module is a light source and the module is located remotely from the remainder of the plurality of functional components. In these embodiments, the remote module may be located more than 1 km or more than 10 km or more than 50 km from the remainder of the plurality of functional components. The light source module may be connected to the remainder of the plurality of functional components by optical fibre.

The one or more of the plurality of functional components may be provided on a separate circuit board to one or more of the remainder of the plurality of functional components.

The module may be connected to one or more other of the plurality of functional components and may be disconnectable therefrom. The apparatus may comprise multiple modules each containing one of the plurality of functional components. The modules may be connectable to each other and disconnectable from each other.

The module may comprise a separate, self-contained unit. The apparatus may be a quantum transmitter or may be a quantum receiver.

According to a further aspect of the invention there is provided a system for performing quantum key distribution, the system comprising:

A quantum transmitter having a first plurality of connected functional components which, in use, co-operate to perform quantum key distribution with the quantum receiver,

A quantum receiver having a second plurality of connected functional components which, in use, co-operate to perform quantum key distribution with the quantum transmitter,
wherein one or more of the first and/or second plurality of functional components is provisioned in a module, the module being relocatable relative to the remainder of that plurality of functional components.

### Disconnectability

In known arrangements the components of QKD terminals are provided upon a single integral circuit board. In contrast, according to embodiments of the present invention, the plurality of functional components are disconnectable. This enables, for example, components of a QKD terminal to be replaced if found to be faulty or if an upgraded version of the component is available. Thus the cost of replacing the whole transmitter is avoided.

The apparatus may be a quantum transmitter or may be a quantum receiver or both. The apparatus may be adapted to perform quantum key distribution in accordance with any QKD protocol, e.g prepare-and-measure protocols, quantum entanglement protocols etc. The plurality of connected functional components may, in use, co-operate to prepare a quantum state for transmission in accordance with a quantum key distribution protocol. One or more components may be connected to one or more other components by optical fibre and/or metallic wire. The optical fibre and/or metallic wire may be provided with connectors to connect to the components. Such connectors may be received within corresponding sockets in the one or more components. Some of the components may communicate via free space.

The apparatus may further comprise one or more replacement functional components adapted to connect to the remainder of the plurality of functional components if the one or more of the plurality of functional components are disconnected from the remainder of the plurality of functional components.

If disconnected from the remainder of the plurality of functional components, the one or more of the plurality of functional components may be re-connectable to the remainder of the plurality of functional components.

As the skilled person would understand, a functional component in the context of a QKD apparatus is a component of the QKD apparatus that functionally contributes to the establishment of a quantum key. In embodiments in which the apparatus is a quantum transmitter, the plurality of functional components may comprise one or more of the following:
a source of photons;
a modulator;
control electronics;
a random number generator.

The source of photons may be a laser or may be a single photon transmitter. The source of photons may be connected to the modulator by an optical fibre such that the source of photons can transmit photons to the modulator over the optical fibre. The control electronics may be connected to the random number generator by metallic wire such that the random number generator can transmit a signal over the metallic wire to the control electronics indicative of a generated random number. The control electronics may be connected by respective metallic wire connections to the source of photons and the modulator. The quantum transmitter may further comprise a key establishment module for establishing the quantum key over a classical channel in accordance with QKD protocols. The control electronics may be connected by a metallic wire connection to a key establishment module.

In embodiments in which the apparatus is a quantum receiver, the plurality of functional components may comprise one or more of the following:
a demodulator;
control electronics;
a first photodetector;
a second photodetector.

The control electronics may be connected by respective metallic wire connections to the demodulator and to the first and second photodetectors. The demodulator may be connected by respective optical fibres to the first and second photodetectors. The quantum receiver may further comprise a key establishment module for establishing the quantum key over a classical channel in accordance with QKD protocols. The control electronics may be connected by a metallic wire connection to the key establishment module.

### Shared Components

In some embodiments, one or more of the plurality of connected functional components is further connected to one or more further QKD apparatuses. The one or more of the plurality of connected functional components may be provisioned in a separate module which may be spaced apart from the remainder of the plurality of functional components of the QKD apparatus and may be spaced apart from the one or more further QKD apparatuses. The separate module may be connectable to the remainder of the plurality of functional components of the QKD apparatus and/or the one or more further QKD apparatuses by optical fibre and/or metallic wiring and/or free space. The one or more of the plurality of connected functional components may be disconnectable from the remainder of the plurality of functional components of the QKD apparatus and may be disconnectable from the one or more further QKD apparatuses.

These embodiments are advantageous as, e.g., the functionality of certain components can be shared between multiple QKD apparatuses. In embodiments where the QKD apparatus is a quantum transmitter, the one or more of the plurality of connected functional components may comprise a control electronics module and/or a random number generator. In some embodiments a single control electronics module and/or a random number generator serve a plurality of transmitter assemblies each having a photon source and a modulator. In embodiments where the QKD apparatus is a quantum receiver, the one or more of the plurality of connected functional components may comprise a control electronics module. The control electronics module may server a plurality of receiver assemblies each having a demodulator and first and second detectors.

The QKD apparatus may be located in a quantum node. A plurality of QKD apparatuses in accordance with the invention may be located in the quantum node. The quantum node may comprise one or more further quantum transmitters and one or more further quantum receivers.

In embodiments where the QKD apparatus is a quantum transmitter, the one or more of the plurality of connected functional components is further connected to one or more quantum receivers. In embodiments where the QKD apparatus is a quantum receiver, the one or more of the plurality of connected functional components is further connected to one or more quantum transmitters.

Some embodiments comprise a system for performing quantum key distribution, the system comprising a quantum transmitter having a first plurality of connected functional components which, in use, co-operate to perform quantum key distribution with the quantum receiver, and a quantum receiver having a second plurality of connected functional components which, in use, co-operate to perform quantum key distribution with the quantum transmitter, wherein one or more of the first and/or second plurality of functional components are disconnectable from the remainder of that plurality of functional components.

A specific embodiment of the invention will now be described, for illustration only, and with reference to the appended drawings, in which:

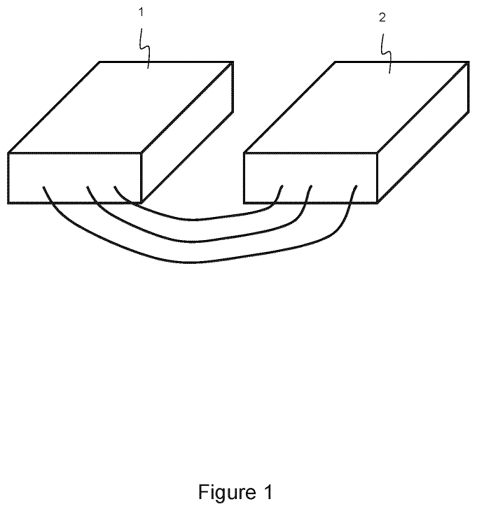

FIG. 1 is a 3D schematic view of a known QKD transmitter and receiver;

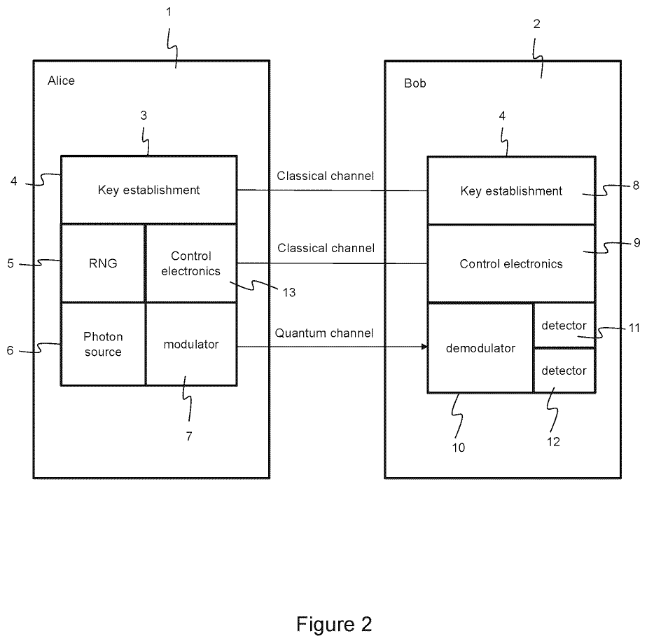

FIG. 2 is a schematic view of a known QKD transmitter and receiver;

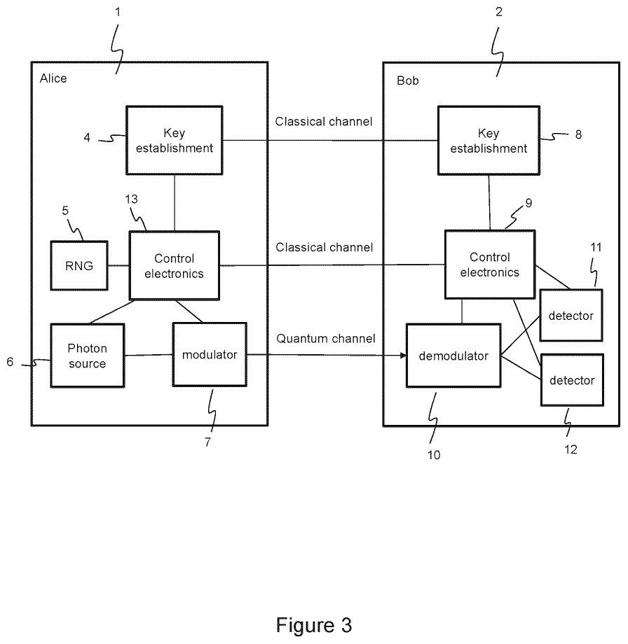

FIG. 3 is a schematic view of a QKD transmitter and receiver in accordance with the invention;

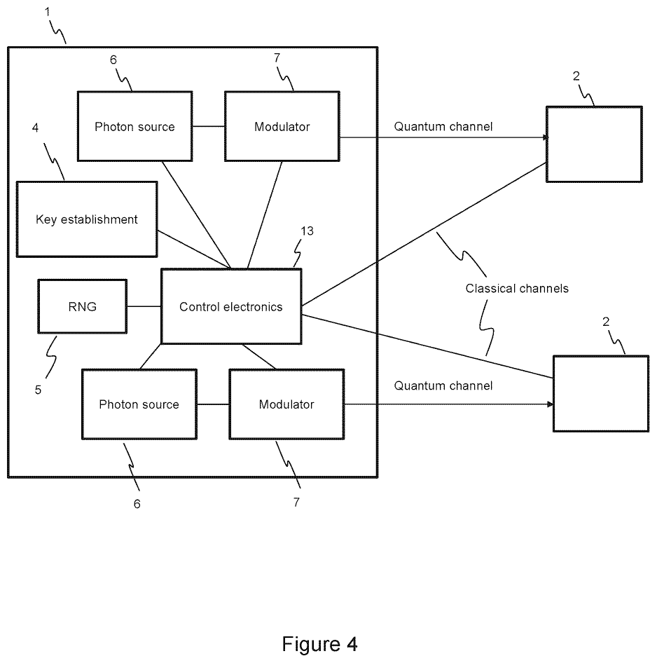

FIG. 4 is a schematic view of a QKD transmitter in accordance with an embodiment of the invention;

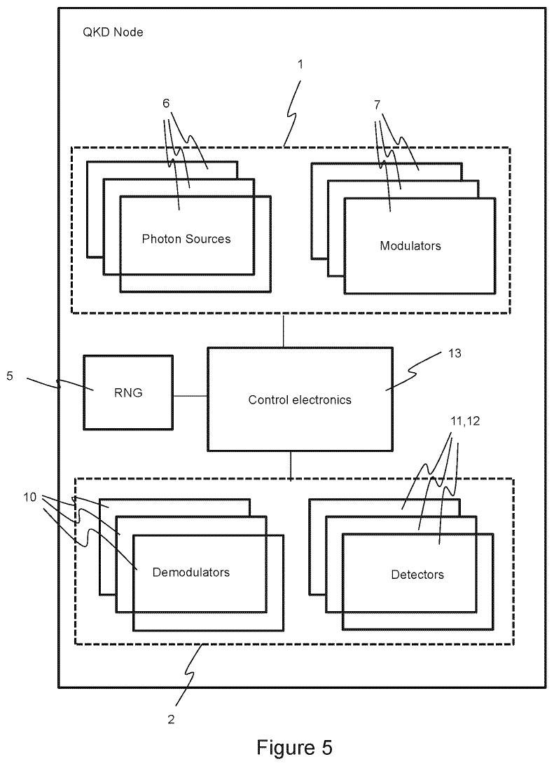

FIG. 5 is a schematic view of a QKD transmitter in accordance with a further embodiment of the invention.

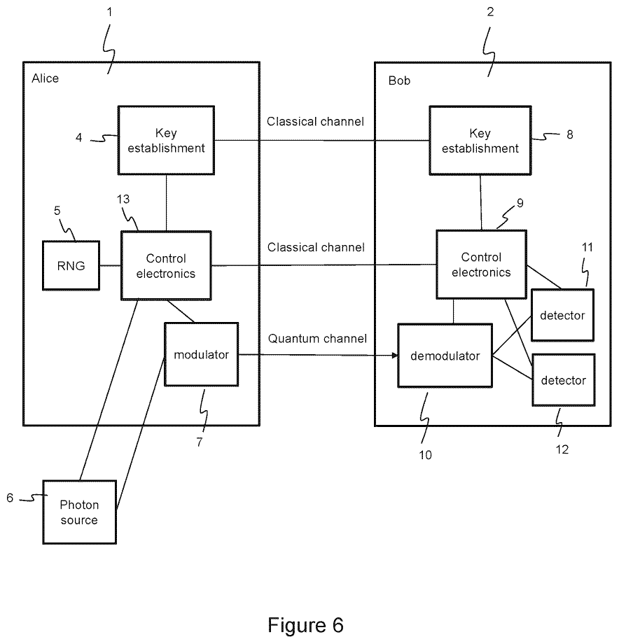

FIG. 6 is a schematic view of a QKD transmitter in accordance with an embodiment of the invention.

FIG. 1 is a 3D schematic representation of a known QKD system. In particular, there is an Alice unit 1 (i.e. a quantum transmitter) and a Bob unit 2 (i.e. a quantum receiver). Alice 1 is connected to Bob 2 by three optical fibres representing a quantum channel and two classical channels respectively.

The arrangement of FIG. 1 is shown in more detail in FIG. 2. In particular, FIG. 2 shows that Alice 1 contains a transmitter 3 and Bob 2 contains a receiver 4. Transmitter 3 comprises several component elements. These are a key establishment 4, random number generator 5, control electronics 13, laser photon source 6 and quantum modulator 7. Transmitter 3 is a chip and these component elements are written on the chip. The transmitter 3 is a single unitary object. The component parts are not separate from each other, nor are they separable or reconnectable.

The receiver 4 of Bob 2 comprises several component elements. These are a key establishment element 8, control electronics 9, quantum demodulator 10 and photo detectors 11 and 12. Receiver 4 is a chip and these component elements are written on the chip. The receiver 4 is a single unitary object. The component parts are not separate from each other, nor are they separable or reconnectable.

As the skilled person would understand, in use the random number generator in the transmitter 3 of Alice 1 generates a random number. The control electronics 13 inputs the random number to modulator 7. The photon source 6 generates a photon and outputs it to the modulator which, using the random number prepares a quantum state for transmission. This is a qubit having a randomly-chosen encoded value of 0 or 1, prepared in a randomly-chosen basis state. This quantum state is transmitted to Bob 2 which, using the demodulator 10 and detectors 11 and 12, measures the quantum state in a randomly-chosen basis state. If the basis state in which Bob measures the quantum state is the same as that which Alice 1 used to prepare the quantum state, then Bob's detectors will measure the bit value that Alice encoded onto the photon correctly. If the basis state in which Bob 2 measures the quantum state is different to that Alice used to prepare the quantum state, then Bob's detectors may not measure the bit value that Alice encoded onto the photon correctly. This photon transmission process is repeated for multiple photons. Alice then transmits to Bob over one of the classical channels, a list of the basis states she used to prepare the photons. Bob sends Alice a list of the basis states he used to measure the photons. Alice and Bob then each discard the bit values in respect of the photons for which Alice and Bob used different basis states. Alice and Bob are then left with identical lists of bit values (i.e. the bit values encoded onto the photons in respect of which Alice and Bob used the same basis states). Alice and Bob then use these two identical lists as a quantum-encrypted key for secret communication.

FIG. 3 is a schematic view of an embodiment according to the invention. FIG. 3 contains Alice 1 and Bob 2 along with all of the component elements 4,5,6,7 of Alice and Bob that are shown in FIG. 2. These components have the same reference numerals as in FIG. 2. The difference between FIG. 3 and FIG. 2 is that in FIG. 3, the component elements are not part of unitary transmitter/receiver modules, marked as 3 and 4 respectively in FIG. 2. Instead, the components in FIG. 3 are separate modules. The modules are spaced apart from each other and are relocatable relative to each other. The modules are connected to each other by optical fibre or wiring as appropriate. The optical fibres or wiring are provided with connectors which are received within corresponding sockets in the components. Such connections are familiar to the skilled person and so will not be described in detail here.

In particular, starting with Alice 1, control electronics 13 is connected by wiring to key establishment module 4, random number generator 5, photon source 6 and modulator 7. Control electronics 13 receives inputs and provides outputs to the other components over the wiring in the same way as in FIG. 2. Similarly, as in FIG. 2, photon source 6 transmits photons to modulator 7. However in FIG. 3, this transmission takes place via optical fibre. Similarly, at Bob 2, control electronics 9 communicates with the other components in Bob 2 via wiring in FIG. 3. Furthermore, demodulator 10 directs received photons to detectors 11 and 12 via optical fibre.

One or more of the modules 4, 5, 6, 7, 13 of Alice 1 can be located remotely from Alice 1. For example, Alice 1 is located in a quantum node and one or more of the modules 4, 5, 6, 7, 13 are located in the exchange which is 10 km or more from the quantum node. The remote module is connected to the remainder of the components by optical fibre or metallic wire as appropriate. An arrangement in which the photon source is located externally to Alice is shown in FIG. 6. Similarly, one or more of the component modules 8, 9, 10, 11 and 12 of Bob 2 can be located remotely from Bob 2.

The modules 4, 5, 6, 7, 13 of Alice 1 can be disconnected and removed from Alice 1, and once removed, can be reconnected to Alice 1. Thus if one of the component modules 4, 5, 6, 7, 13 of Alice were to break, or needed to be replaced by a newer model, such replacement is possible. Similarly, the component modules 8, 9, 10, 11 and 12 of Bob 2 can be disconnected and removed from Bob 2, and once removed, can be reconnected to Bob 2.

FIG. 4 shows a further arrangement according to the invention. Again, like components have the same reference numerals as in FIGS. 2 and 3. In FIG. 4 there is one Alice 1 and two Bobs 2. In FIG. 4, the control electronics module 13, the random number generator module 5 and the key establishment module 4 are shared by two photon source/modulator pairs 6,7. Each of the two photon source/modulator pairs 6,7 has its own quantum channel connecting the two modulators 7 to the two Bobs respectively. Furthermore, a respective classical channel extends from the control electronics 13 to each of Bobs 2. Thus, QKD can be performed by Alice 1 and Bobs 2 in which Alice contains only one control electronics element 13, random number generator 5 and the key establishment element 4. This sharing of components brings cost savings.

FIG. 5 is a schematic view of a QKD node containing multiple Alice 1 and a Bob 2 units. Each Alice 1 contains a photon source modules 6 and a modulator module 7. Each Bob contains a demodulator module 10 and detector modules 11, 12. The multiple Alice 1 and Bobs 2 are served by a single random number generator module 7 and a single control electronics module 13. This illustrates how components can be shared between Alice and Bob units in a quantum node.

1. An apparatus for performing quantum key distribution, the apparatus comprising:
a plurality of connected functional components which, in use, co-operate to perform quantum key distribution,
wherein one or more of the plurality of functional components is provisioned in a module, the module being relocatable relative to the remainder of the plurality of functional components.

2. An apparatus according to claim 1, in which a single one of the plurality of functional components is provisioned in the module.

3. An apparatus according to claim 1, in which each of the plurality of functional components is provisioned in a separate module.

4. An apparatus according to claim 3, in which the one or more modules are located remotely from the remainder of the plurality of functional components.

5. An apparatus according to claim 4, in which the functional component that is provisioned in the module is a light source.

6. An apparatus according to claim 5, in which the remote module is located more than 1 km from the remainder of the plurality of functional components.

7. An apparatus according to claim 5, in which the module may be connected to the apparatus by optical fibre.

8. An apparatus according to claim 1, in which the module may comprise a separate, self-contained unit.

9. A system for performing quantum key distribution, the system comprising:
A quantum transmitter having a first plurality of connected functional components which, in use, co-operate to perform quantum key distribution with the quantum receiver,
A quantum receiver having a second plurality of connected functional components which, in use, co-operate to perform quantum key distribution with the quantum transmitter,
wherein one or more of the first and/or second plurality of functional components is provisioned in a module, the module being relocatable relative to the remainder of that plurality of functional components.
